(19) United States
(12) Patent Application Publication
(10) Pub. No.: US 2020/0379991 A1
(43) Pub. Date: Dec. 3, 2020

(54) Monitoring Subsystem for Computer Systems

(71) Applicant: EMC IP Holding Company LLC, Hopkinton, MA (US)

(72) Inventors: Maksim Vazhenin, Saint Petersburg (RU); Mikhail Danilov, Saint Petersburg (RU)

(21) Appl. No.: 16/426,179

(22) Filed: May 30, 2019

(51) Int. Cl. G06F 16/2458; G06F 16/21

(52) U.S. Cl. CPC G06F 16/2477; G06F 16/219

(57) ABSTRACT

Techniques are provided for a monitoring subsystem for computer systems. In an example, a plurality of time series databases (TSDBs) can determine monitoring information for a plurality of computing nodes. A metrics reporting server can maintain an availability history for each TSDB that it communicates with. The metrics reporting server can implement a greedy heuristic to determine which TSDBs to query for a given time window. The metrics reporting server can use the responses from these queries to assemble monitoring information for the time window.

### TECHNICAL FIELD

The present application relates generally to monitoring a status of data storage systems.

### BACKGROUND

A cluster-based storage system can comprise a plurality of computing nodes. Each computing node can manage one or more storage devices (e.g., a hard drive).

### BRIEF DESCRIPTION OF THE DRAWINGS

Numerous aspects, embodiments, objects, and advantages of the present invention will be apparent upon consideration of the following detailed description, taken in conjunction with the accompanying drawings, in which like reference characters refer to like parts throughout, and in which:

FIG. 1 illustrates a block diagram of an example computer system that can facilitate a monitoring subsystem for computer systems, in accordance with certain embodiments of this disclosure;

FIG. 2 illustrates an example of availability histories of a plurality of time series databases (TSDBs), in accordance with certain embodiments of this disclosure;

FIG. 3 illustrates the example of availability histories of FIG. 2 after performing one iteration of selecting a TSDB, in accordance with certain embodiments of this disclosure;

FIG. 4 illustrates an example of an availability history for a time window that is drawn from the TSDBs of FIGS. 2 and 3, in accordance with certain embodiments of this disclosure;

FIG. 5 illustrates an example of selecting between two TSDBs based on total values, in accordance with certain embodiments of this disclosure;

FIG. 6 illustrates an example of selecting between two TSDBs based on a number of intersections, in accordance with certain embodiments of this disclosure;

FIG. 7 illustrates an example of selecting between two TSDBs based on availability history, in accordance with certain embodiments of this disclosure;

FIG. 8 illustrates an example of selecting between two TSDBs where they have equal total values, number of intersections, and availability histories, in accordance with certain embodiments of this disclosure;

FIG. 9 illustrates an example process flow for monitoring computer systems, in accordance with certain embodiments of this disclosure;

FIG. 10 illustrates an example process flow for determining input for monitoring computer systems, in accordance with certain embodiments of this disclosure;

FIG. 11 illustrates an example process flow for selecting a TSDB among a plurality of TSDBs for monitoring computer systems, in accordance with certain embodiments of this disclosure;

FIG. 12 illustrates an example process flow for producing output for monitoring computer systems, in accordance with certain embodiments of this disclosure;

FIG. 13 illustrates an example process flow for generating monitoring information for monitoring computer systems from the output of the process flow of FIG. 12, in accordance with certain embodiments of this disclosure;

FIG. 14 illustrates an example process flow for monitoring computer systems where a TSDB becomes unavailable before querying begins, in accordance with certain embodiments of this disclosure;

FIG. 15 illustrates an example process flow for monitoring computer systems where a TSDB becomes unavailable after querying begins, in accordance with certain embodiments of this disclosure;

FIG. 16 illustrates another example process flow for monitoring computer systems, in accordance with certain embodiments of this disclosure;

FIG. 17 illustrates an example of an embodiment of a system that can be used in connection performing certain embodiments of this disclosure.

### DETAILED DESCRIPTION

### Overview

There are cluster-based storage systems, such as a DELL Elastic Cloud Storage (ECS) system. Such storage systems can comprise a monitoring subsystem, which monitors a status of one or more nodes of the storage system.

A problem with monitoring a status of one or more nodes of a storage system can be a relatively high resource consumption in performing this monitoring. A solution to a problem of resource consumption can be a more resource efficient approach to monitoring a status of one or more nodes of a storage system, as described herein.

A cluster-based storage system can comprise a plurality of computing nodes. Each computing node can manage one or more storage devices (e.g., a hard drive). Each computing node also can run a number of storage services. Statistics for a computing node can be maintained regarding to serviceability and monitoring of the computing node, and these statistics can indicate a cluster-based storage system's state and a progress of key storage processes visible to end users and to service personnel. In some examples, monitoring can be performed at three levels of a cluster-based storage system: at a computing node level, at a shard level, and at a cluster level.

At a node level, a monitoring agent can be implemented for collecting and reporting system metrics. A monitoring agent can accumulate and report metrics from other storage services of a particular computing node. A monitoring agent can maintain a set of its own independent probes to monitor general system state of a computing node (e.g., central processing unit (CPU) utilization, or random access memory (RAM) consumption). In some examples, so as not to overwhelm a cluster-based storage system's network with small messages, a monitoring agent can implement one instance per computing cluster node, and handle local storage services for that node.

A shard can comprise a plurality of computing nodes (e.g., eight computing nodes) within a cluster-based storage system that are monitored by a time series database (TSDB). At a shard level, a TSDB can be implemented, which stores and reports system metrics gathered by the node-level monitoring agents.

Monitoring agents can periodically send new data to one or more TSDBs. In some examples, there can be a certain availability requirement for a monitoring feature. For example, the availability requirement can be that monitoring can survive an unavailability of two TSDBs. In such examples, a monitoring agent can report to three instances of a TSDB, and three instances of a TSDB can monitor each shard.

In some examples, a computing node that runs an active instance of a TSDB can become overwhelmed with metrics reports from monitoring agents where that TSDB instance serves all cluster computing nodes. To address this issue, the computing nodes of a cluster-based storage system can be divided into shards, where a TSDB can then monitor one shard rather than all computing nodes of the cluster-based storage system.

At the cluster level, a storage service that can be referred to as a metrics reporting service can be implemented. A metrics reporting server can receive requests from its cluster-based storage system's management and monitoring clients (e.g., a web-based dashboard), and handle these requests at the cluster level. That is, a metrics reporting server can provide monitoring information for all of the computing nodes of a particular cluster-based storage system. In some examples, a metrics reporting server can be implemented as a separate Hypertext Transfer Protocol (HTTP) or Hypertext Transfer Protocol Secure (HTTPS) server.

In some examples, an availability requirement specifies that a cluster-based storage system have at least three instances of a metrics reporting server. Then, in some examples, management and monitoring clients are configured to connect to any instance of a metrics reporting server. A metrics reporting server can implement or reuse a general purpose query language that can be used to query a cluster-based storage system for historical or current monitoring data. When a metrics reporting server receives a request that relates to an entire cluster-based storage system, the metrics reporting server can collect data from all shards of the cluster-based storage system (via one or more TSDBs of a shard), merge that data, and send the results to a client.

Each cluster node can run an instance of a monitoring agent. Each monitoring agent can gather node-local metrics. Multiple nodes can be united in a shard. As depicted, each shard has three instances of a TSDB. Monitoring agents within a shard can send metrics to all shard-local TSDBs. The cluster-level metrics reporting server can collect data from shards, aggregate it, and send monitoring data back to a client, upon a request from a management or monitoring client.

An approach for monitoring computer subsystems can involve merging monitoring data from peer TSDBs of each shard, which can assure a desired level of fault tolerance. This approach can have a problem of redundant network traffic, with all TSDBs reporting, and extra efforts on deduplication of monitoring data.

A more efficient approach for monitoring computer subsystems can be implemented that assures a desired level of fault tolerance. In a more efficient approach, a metrics reporting server can omit requesting the same monitoring data from all TSDBs of one shard. Rather, a single piece of monitoring data can be requested from one TSDB. A particular TSDB can go offline at unpredictable moments of time, so there can be situations where a particular TSDB lacks desired monitoring data. In some examples, a metrics reporting server might not be aware of the availability history of TSDBs. Therefore, when monitoring data is to be determined for a time window, a metrics reporting server might not know which TSDB(s) contain the corresponding monitoring data.

In such an approach, a metrics reporting server can monitor availability of all of the TSDBs that the metrics reporting server can use to obtain monitoring information. A metrics reporting server can maintain a per-TSDB monitored network connection. This way, a metrics reporting server can detect times at which a given TSDB is offline. A metrics reporting server can maintain a history of availability for each of its TSDBs. In some examples, to limit use of storage resources consumed by availability histories, a TSDB can use retention and expiration for monitoring data. That is, a TSDB can maintain particular monitoring data for a limited time period.

Similarly, a metrics reporting server can use retention and expiration for maintaining an availability history of its TSDBs. In some examples, when monitoring data is requested for a time period that is beyond a known history of availability of TSDBs, a metrics reporting server can request the monitoring data from all currently available TSDBs. In some examples, this fall back logic can be used for systems recently upgraded to implement this more efficient approach, since they can have short availability histories for TSDBs.

In some examples, when a request is made to a metrics reporting server for monitoring data for a certain time window, the metrics reporting server reconstructs the time window using periods of availability of its TSDBs. There can be a plurality of ways to reconstruct a time window using periods of availability of different TSDBs. A goal can be to serve a request to a metrics reporting server using a minimal number of requests to its TSDBs. In some examples where one query to a TSDB can contain multiple non-adjacent time intervals, a number of TSDBs to be queried for monitoring data to serve a request to a metrics reporting server can be used as an objective function. In some examples, a goal can be to reduce or minimize this objective function.

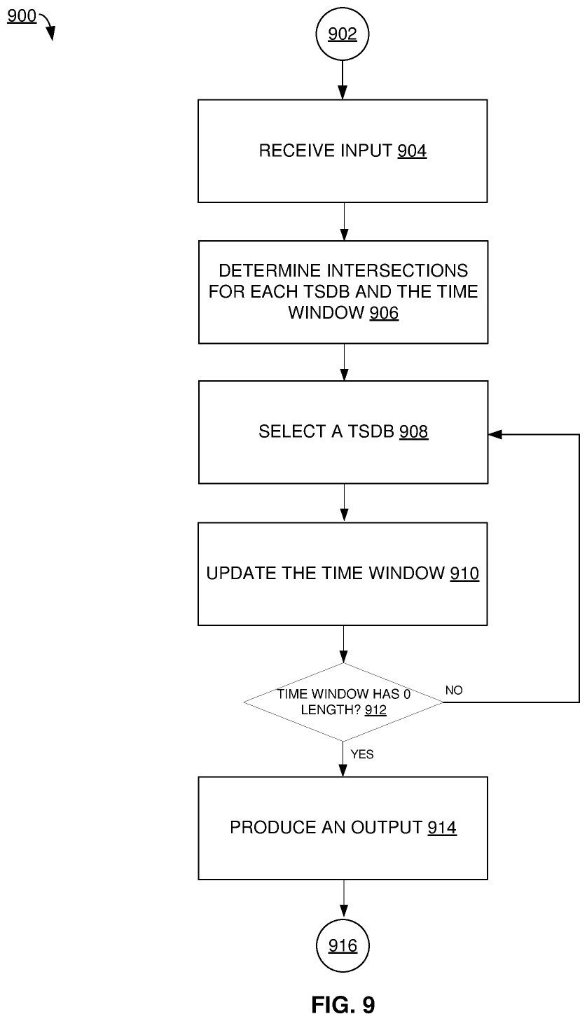

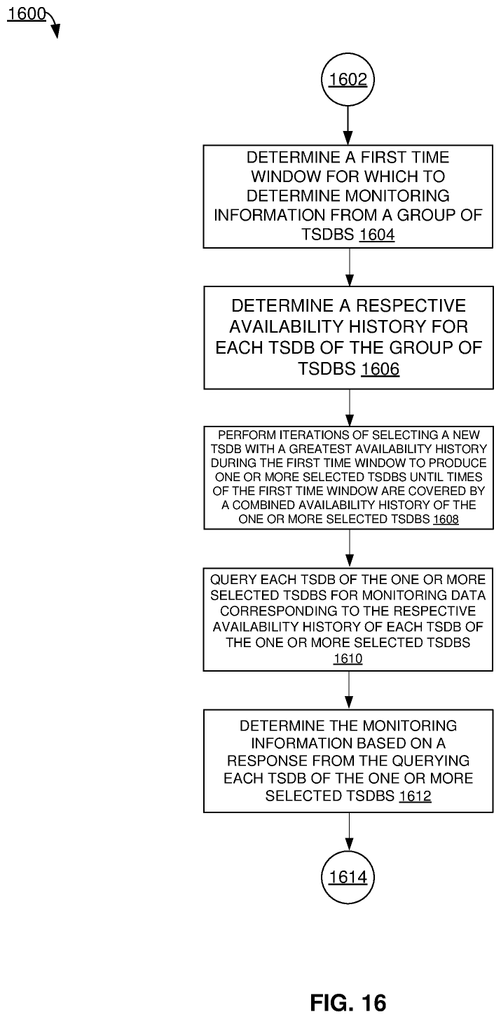

In some examples, an optimal solution could involve an exhaustive search, which can consume a large amount of computing resources. A heuristic greedy approach can be implemented, which can conserve computing resources relative to an optimal solution. An example of a heuristic greedy approach is described with respect to process flow 900 of FIG. 9, and to process flow 1600 of FIG. 16.

In some examples, availability of TSDBs during serving a request for monitoring data might not be guaranteed. Where a TSDB to query becomes unavailable before a metrics reporting server starts querying TSDBs, the metrics reporting server can completely re-run its approach to select TSDBs to produce completely new output. Where a TSDB to query becomes unavailable after a metrics reporting server starts querying its TSDBs, the metrics reporting server can re-run its approach using the list of time intervals produced for the problematic TSDB as an initial time window.

### Example Architecture

The disclosed subject matter is now described with reference to the drawings, wherein like reference numerals are used to refer to like elements throughout. In the following description, for purposes of explanation, numerous specific details are set forth in order to provide a thorough understanding of the disclosed subject matter. It may be evident, however, that the disclosed subject matter may be practiced without these specific details. In other instances, well-known structures and devices are shown in block diagram form in order to facilitate describing the disclosed subject matter.

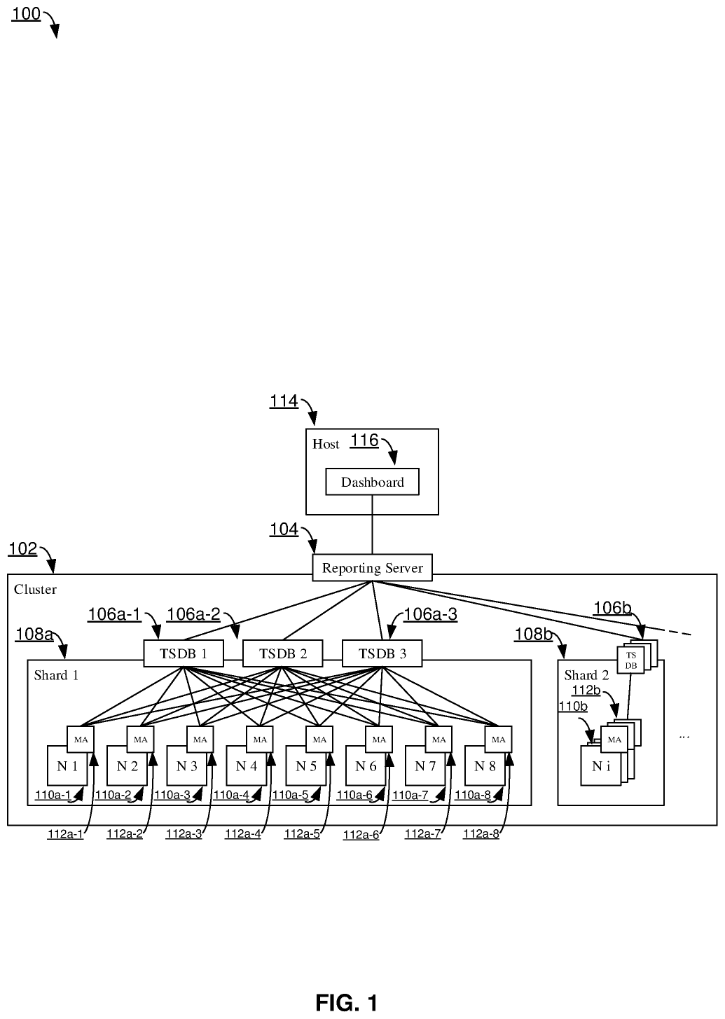

FIG. 1 illustrates a block diagram of an example computer system 100 that can facilitate a monitoring subsystem for computer systems, in accordance with certain embodiments of this disclosure. Computer system comprises cluster 102, and host 114. In turn, host 114 comprises dashboard 116. Likewise, cluster 102 (which can be referred to as a cluster-based storage system) comprises reporting server 104 (which can be referred to as a metrics reporting server), shard 1 108a, and shard 2 108b. There are two shards depicted—shard 1 108a and shard 2 108b—and it can be appreciated that there can be examples where a cluster comprises more than two shards, or fewer than two shards.

Each shard is depicted as comprising three TSDBs, and eight computing nodes, where each computing node has an instance of a monitoring agent. That is, shard 1 108a is depicted as comprising TSDB 1 106a-1, TSDB 2 106a-2, and TSDB 3 106a-2. Similarly, shard 2 108b is depicted as containing three TSDBs in TSDBs 106b.

Similarly, in FIG. 1, a shard is depicted as containing eight computing nodes—e.g., shard 1 108a is depicted as containing computing node 110a-1, computing node 110a-2, computing node 110a-3, computing node 110a-4, computing node 110a-5, computing node 110a-6, computing node 110a-7, and computing node 110a-8. It can be appreciated that there can be examples where a shard comprises more than eight computing nodes, or fewer than eight computing nodes.

Each computing node is depicted as having an instance of a monitoring agent. In shard 1 108a, computing node 110a-1 has monitoring agent 112a-1, computing node 110a-2 has monitoring agent 112a-2, computing node 110a-3 has monitoring agent 112a-3, computing node 110a-4 has monitoring agent 112a-4, computing node 110a-5 has monitoring agent 112a-5, computing node 110a-6 has monitoring agent 112a-6, computing node 110a-7 has monitoring agent 112a-7, and computing node 110a-8 has monitoring agent 112a-8. Similarly, in shard 2 108b, computing nodes 110b each have an instance of monitoring agents 112b.

### Example Availability Histories

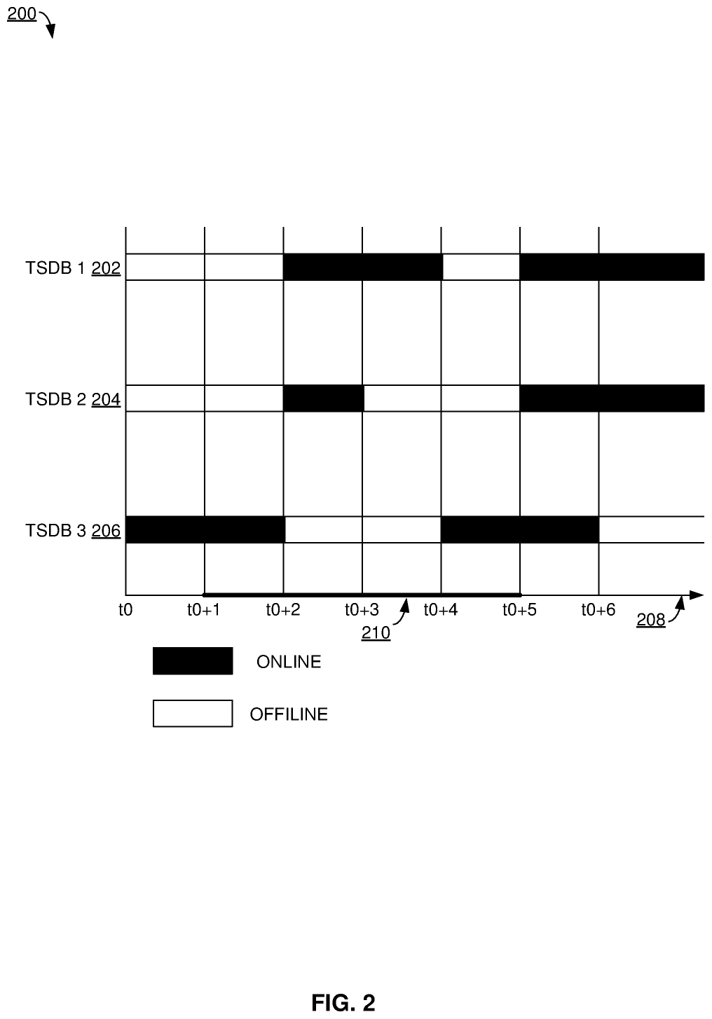

FIG. 2 illustrates an example of availability histories 200 of a plurality of TSDBs, in accordance with certain embodiments of this disclosure. In some examples, availability histories 200 can be evaluated by reporting server 104 of FIG. 1 in the course of facilitating a monitoring subsystem for computer systems.

Availability histories 200 indicates availability histories of three TSDBs—TSDB 1 202, TSDB 2 204, and TSDB 3 206—and shows availability histories for these three TSDBs over times 208. Times 208 are shown from time t0 to time t0+6. As depicted, TSDB 1 is online, or available, from time t0+2 through t0+4, and then after t0+6. TSDB 2 is online from time t0+1 through t0+3, and then from time t0+5 onward. TSSDB 3 is available from time t0 to t0+2, and time t0+4 to t0+6.

A metrics reporting server, such as reporting server 104 of FIG. 1, can evaluate the availability histories of TSDBs (such as TSDB 1 106a-1, TSDB 2 106a-2, and TSDB 3 106a-3) to determine which TSDBs to query for which time periods to determine monitoring information for a given time window, here time window 210, which runs from t0+1 through t0+5. The metrics reporting server can perform iterations of selecting a TSBD to do this determining which TSDBs to query for which time periods to determine monitoring information for a given time window.

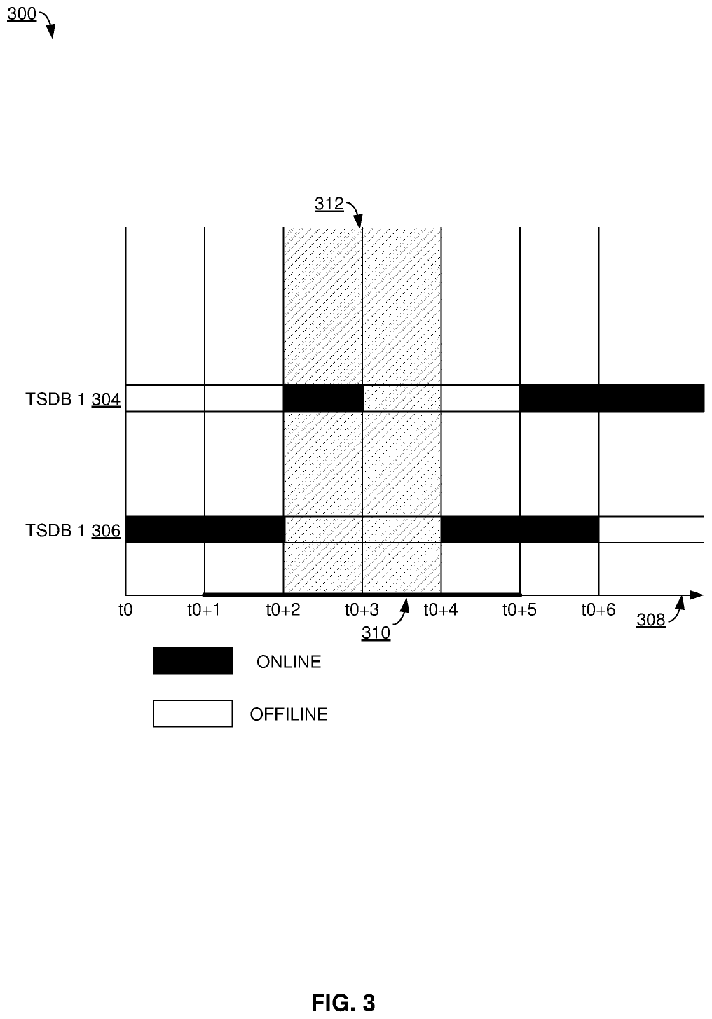

In performing a first iteration of an approach to selecting TSDBs, TSDB 1 202 is selected. Each of TSDB 1 202, TSDB 2 204, and TSDB 3 206 is available for the same value of time during the time window—two time units. TSDB 3 206 is eliminated from consideration during this time period because it has more intersections with the time window—two—than do TSDB 1 202 and TSDB 2 204, which each have one intersection with the time window. TSDB 1 202 and TSDB 2 204 each have a same availability history. So, in this example approach, then either TSDB 1 202 or TSDB 2 204 can be selected during this iteration. In this example, TSDB 1 202 is selected, and a result of selecting TSDB 1 202 is depicted in FIG. 3.

Here, there are three TSDBs in the shard. Periods of availability and unavailability of each TSDB are shown. A metrics reporting server can be requested to provide monitoring data for the time window [t0+1, t0+5). At the moment the request comes in, all the TSDBs are available.

In some examples, the metrics reporting server performs two iterations to compile a list of TSDBs to query. During the first iteration, the metrics reporting server can determine that two of the TSDBs—TSDB 1 202 and TSDB 3 206—cover half of the time window, with a total value of two time units. This is greater than the total value of TSDB 2 204, which is one time unit. TSDB 1 202 can be chosen during the first iteration as it can half of the time window with a single time interval [t0+2, t0+4), while TSDB 3 206 requires two time intervals, [t0+1, t0+2), and [t0+4, t0+5). That is, TSDB 1 202 has one intersection with the time window, while TSDB 3 206 has two intersections with the time window.

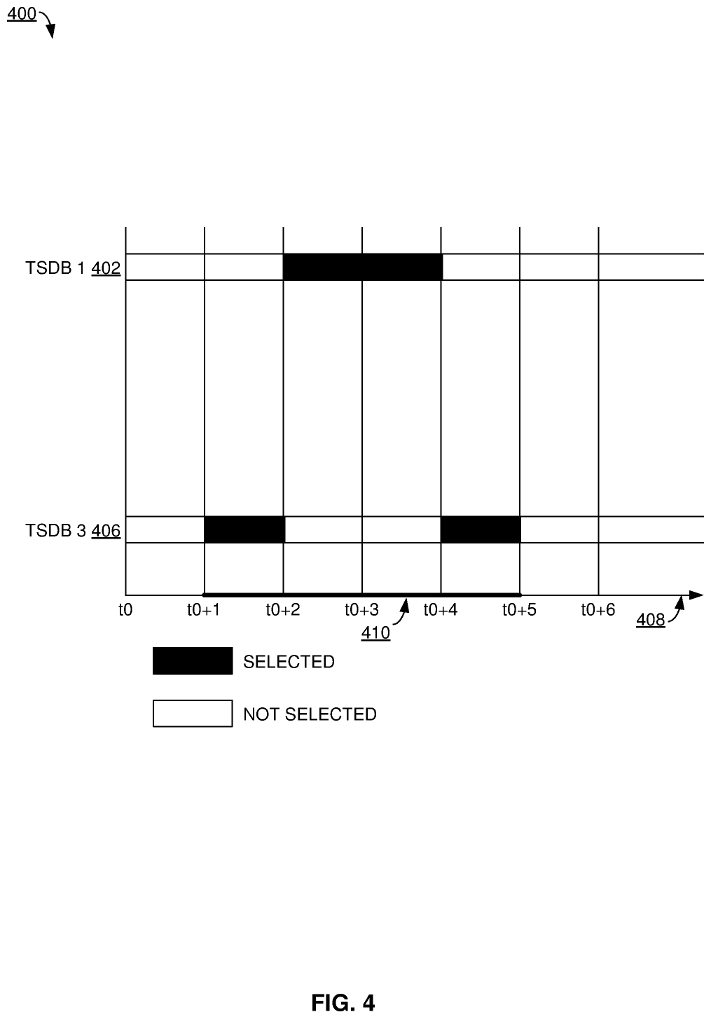

During a second iteration (such as depicted between FIGS. 3 and 4), a metrics reporting server can select TSDB 3 206 because it has a greater total value for the remaining time window than TSDB 2 204. The time window can be updated again to reflect that TSDB 3 206 has been selected. Updating the time window reduces the remaining portions of the time window to zero, so the metrics reporting server can conclude performing iterations.

The request of monitoring data can be served using two TSDBs. TSSDB 1 202 can be queried for data from the time interval [t0+2, t0+4), and TSDB 3 206 can be queried for the time intervals [t0+1, t0+2), and [t0+4, t0+5).

This approach can be practical to implement. In some examples, his approach can reduce the amount of data to be extracted from TSDBs and sent to one or more metrics reporting servers over network by two-thirds. This approach can also reduce overhead on the processing of monitoring data.

FIG. 3 illustrates the example of availability histories of FIG. 2 after performing one iteration of selecting a TSDB, in accordance with certain embodiments of this disclosure. In some examples, availability histories 300 can be evaluated by reporting server 104 of FIG. 1 in the course of facilitating a monitoring subsystem for computer systems.

Similar to as with FIG. 2, a metrics reporting server, such as reporting server 104 of FIG. 1, can evaluate the availability histories of TSDBs (such as TSDB 1 106a-1, TSDB 2 106a-2, and TSDB 3 106a-3) over times 308 to determine which TSDBs to query for which time periods to determine monitoring information for a given time window, here time window 310, which runs from time t0+1 to t0+2 and time t0+4 to t0+5. A portion of time window 310 (from time t0+2 to time t0+4) is not considered in this intersection because it was selected with TSDB 1 202 in a prior iteration, and that is indicated by already-selected area 312.

The metrics reporting server can perform iterations of selecting a TSBD to do this determining which TSDBs to query for which time periods to determine monitoring information for a given time window.

Availability histories 300 depicts availability histories 200 after TSDB 1 202 was selected in performing the first iteration. Availability histories 300 indicates availability histories of two TSDBs—TSDB 2 304 and TSDB 3 306—and shows availability histories for these two TSDBs over times 208. TSDB 2 304 is similar to TSDB 2 204 of FIG. 2, and TSDB 3 306 is similar to TSDB 3 206. Selected portion 310 indicates an availability history of TSDB 1 202 during the time window, and since TSDB 1 202 was selected during performing the first iteration, selected portion 310 is no longer considered in performing a subsequent iteration.

In this second iteration, TSDB 2 304 and TSDB 3 306 are compared. TSDB 3 306 has a greater total value for the remaining time window (two time units) than TSDB 2 304's total value (one time unit). So, TSDB 3 306 is selected. In selecting TSDB 3 306 in this iteration, all remaining portions of the time window are selected, so the iterations can complete.

FIG. 4 illustrates an example of an availability history 400 for a time window that is drawn from the TSDBs of FIGS. 2 and 3, in accordance with certain embodiments of this disclosure. In some examples, availability history 400 can be evaluated by reporting server 104 of FIG. 1 in the course of facilitating a monitoring subsystem for computer systems.

In FIG. 4, the iteration of FIG. 2 and the iteration of FIG. 3 have been performed to determine which TSDBs will be accessed for the various portions of a time window, here time window 410, which runs from time t0+1 through time t0+5. As depicted, TSDB 3 406 is used for time t0+1 to t0+2 of times 408; TSDB 1 402 is used for time t0+2 to t0+4 of times 408; and TSDB 3 406 is again used for time t0+4 to time t0+5 of times 408. TSDB 3 406 can be similar to TSDB 3 306 and/or TSDB 3 206, and TSDB 1 402 can be similar to TSDB 202.

Using availability history 408, a metrics reporting server can then query the indicated TSDBs for the indicated time periods to receive monitoring information for the time window, and for the shard monitored by these TSDBs. For example, reporting server 104 of FIG. 1 can query TSDB 1 106a-1 and TSDB 3 106a-3 for their availability histories during given time periods, based on having performed these iterations as descried with respect to FIGS. 2-4.

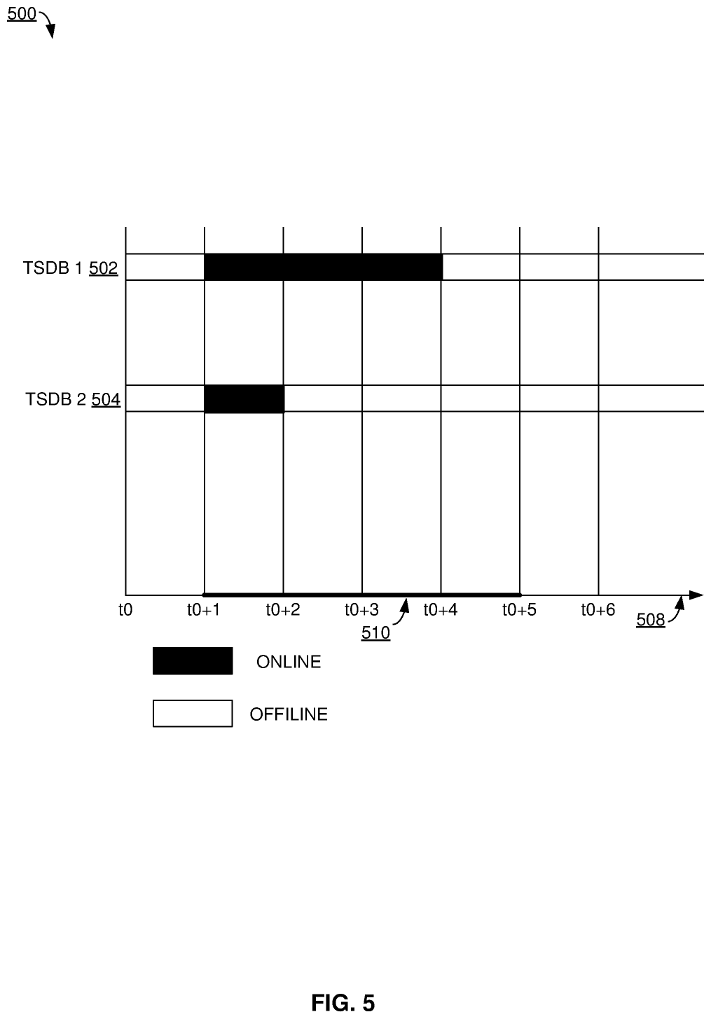

FIG. 5 illustrates an example of selecting between two TSDBs 500 based on total values, in accordance with certain embodiments of this disclosure. In some examples, TSDBs 500 can be evaluated by reporting server 104 of FIG. 1 in the course of facilitating a monitoring subsystem for computer systems.

TSDBs 500 comprises TSDB 1 502 and TSDB 2 504, which have availability histories monitored across times 508 (spanning time t0 through t0+6) and time window 510 (spanning time t0+1 through t0+5).

TSDB 1 502 is available for three time units during the time window—time t0+1 through time t0+4. TSDB 2 504 is available for one unit during the time window—time t0+1 through time t0+2. So, in performing an iteration to select a TSDB, TSDB 1 502 is selected because it is available for more time units during the time window than TSDB 2 504 is (three time units, compared to one time unit).

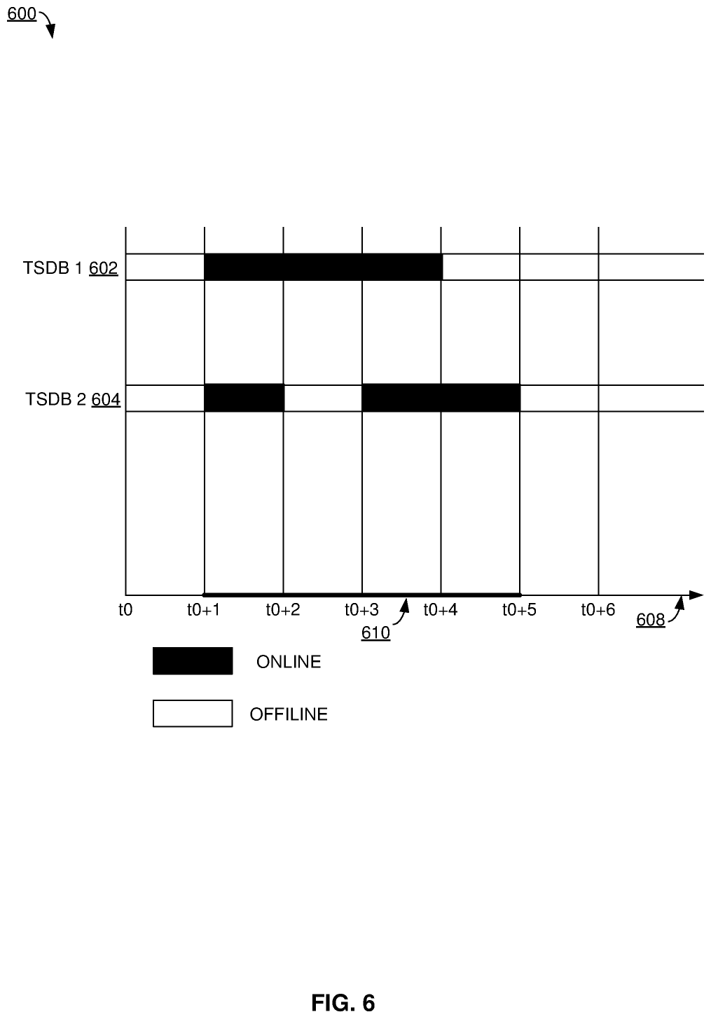

FIG. 6 illustrates an example of selecting between two TSDBs 600 based on a number of intersections, in accordance with certain embodiments of this disclosure. In some examples, TSDBs 600 can be evaluated by reporting server 104 of FIG. 1 in the course of facilitating a monitoring subsystem for computer systems.

In some examples, two or more TSDBs may be selected from based on a number of intersections where they have equal total values. TSDBs 600 comprises TSDB 1 602 and TSDB 2 604, which have availability histories monitored across times 608 (spanning time t0 through t0+6) and time window 610 (spanning time t0+1 through t0+5).

TSDB 1 602 is available for three time units during the time window—time t0+1 through time t0+4. TSDB 2 604 is also available for three units during the time window—time t0+1 through time t0+2, and time t0+3 through time t0+5. Therefore TSDB 1 602 and TSDB 2 604 are available for the same total value during the time window.

Where two or more TSDBs have a same total value for a time window, a TSDB can be selected based on having a lower number of intersections. An intersection can be a number of disjoint periods of availability history within a time window.

Here, TSDB 1 602 has one intersection with the time window—the period from time t0+1 through t0+4. Then, TSDB 2 604 has two intersections with the time window—one intersection for the period from time t0+1 through t0+2, and another intersection for the period from time t0+3 through t0+5. Since TSDB 1 602 has fewer intersections than TSDB 2 604, TSDB 1 602 can be selected while performing an iteration on TSDB 1 602 and TSDB 2 604.

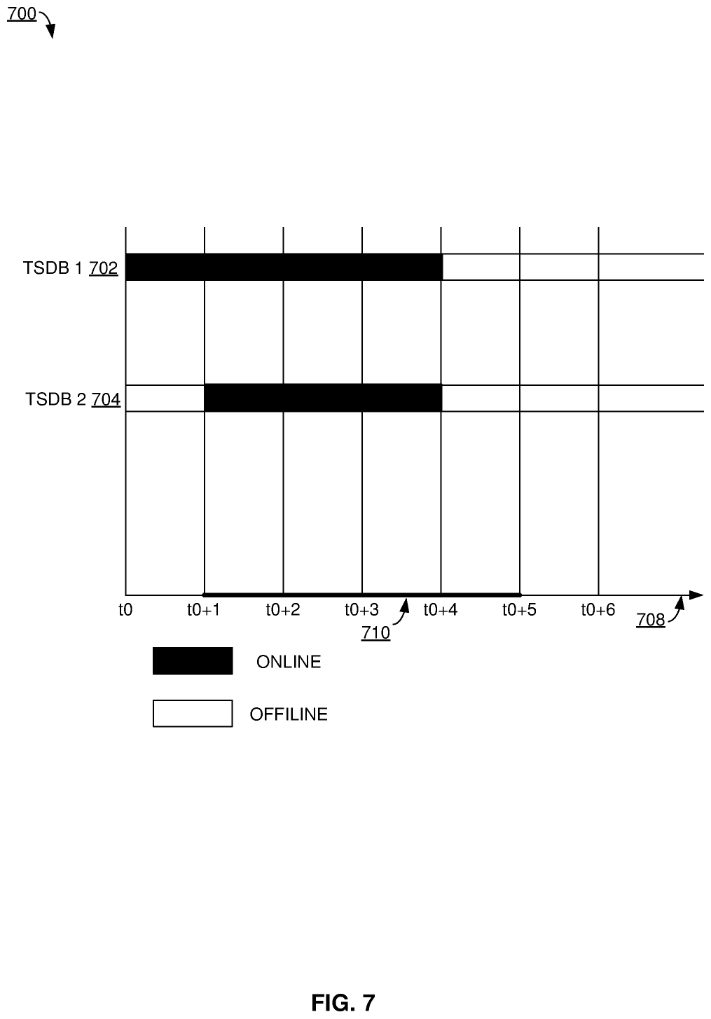

FIG. 7 illustrates an example of selecting between two TSDBs 700 based on availability history, in accordance with certain embodiments of this disclosure. In some examples, TSDBs 700 can be evaluated by reporting server 104 of FIG. 1 in the course of facilitating a monitoring subsystem for computer systems.

In some examples, two or more TSDBs can be selected from based on availability history where they have equal total values and number of intersections. TSDBs 700 comprises TSDB 1 702 and TSDB 2 704, which have availability histories monitored across times 708 (spanning time t0 through t0+6) and time window 710 (spanning time t0+1 through t0+5).

Where two or more TSDBs have a same total value for a time window, as well as a same number of intersections for a time window, then a TSDB can be selected based on having a greater total availability history. A total availability history can comprise an availability history for a TSDB both within and outside of a particular time window.

Here, TSDB 1 702 has an availability history of four time units, from time t0 through t0+4. Note that time window 710 spans time t0+1 through t0+5, so the availability history of TSDB 1 702 from time t0 through t0+1 is outside of time window 710. Then, TSDB 2 704 has an availability history of three time units, from time t0+1 through t0+4. Since TSDB 1 702 has a greater availability history than TSDB 2 704, TSDB 1 702 can be selected while performing an iteration on TSDB 1 702 and TSDB 2 704.

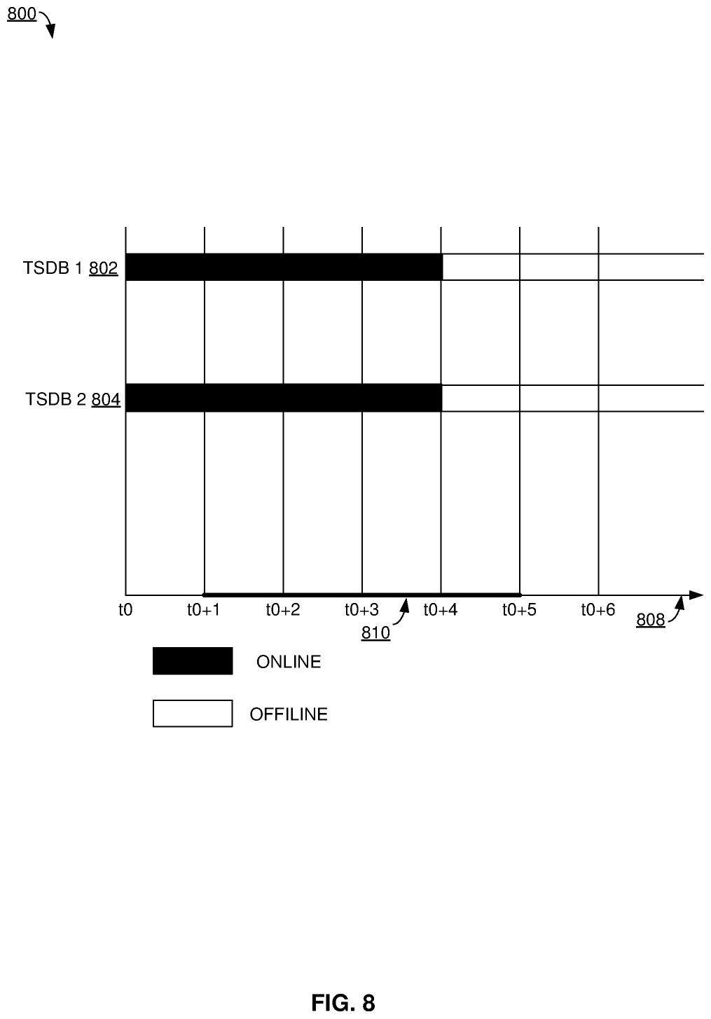

FIG. 8 illustrates an example of selecting between two TSDBs 800 where they have equal total values, number of intersections, and availability histories, in accordance with certain embodiments of this disclosure. In some examples, TSDBs 800 can be evaluated by reporting server 104 of FIG. 1 in the course of facilitating a monitoring subsystem for computer systems.

In some examples, where two or more TSDBs have equal total values, number of intersections, and availability histories, either TSDB can be selected when performing an iteration. TSDBs 800 comprises TSDB 1 802 and TSDB 2 804, which have availability histories monitored across times 808 (spanning time t0 through t0+6) and time window 810 (spanning time t0+1 through t0+5).

Here, TSDB 1 802 has a total value of three time units (from time t0+1 through t0+4), has one intersection with time window 810, and has an availability history of four time units (from time t0 through t0+4). Likewise, TSDB 2 804 also has a total value of three time units (from time t0+1 through t0+4), has one intersection with time window 810, and has an availability history of four time units (from time t0 through t0+4). Since both TSDB 1 802 and TSDB 2 804 have equal values for these three metrics, in some examples, either TSDB 1 802 or TSDB 2 804 can be selected when performing an iteration.

### Example Process Flows

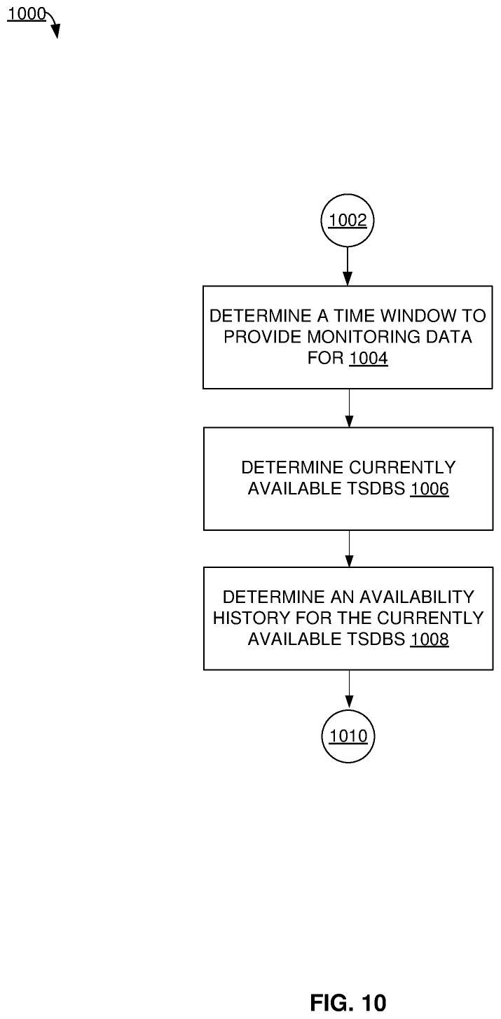

FIG. 9 illustrates an example process flow 900 for monitoring computer systems, in accordance with certain embodiments of this disclosure. In some examples, process flow 900 can be implemented by reporting server 104 of FIG. 1 in the course of facilitating a monitoring subsystem for computer systems. It can be appreciated that process flow 900 is an example process flow, and that there can be process flows that implement more or fewer operations than are depicted in process flow 900, and/or implement the operations of process flow 900 in a different order than is depicted. In some examples, process flow 900 can be implemented in conjunction with one or more other process flows of FIGS. 10-16.

Process flow 900 begins with 902, and then moves to operation 904. Operation 904 depicts receiving input. In some examples, the input received in operation 904 can be the input received in process flow 1000 of FIG. 10. After operation 904, process flow 900 moves to operation 906.

Operation 906 depicts determining intersections for each TSDB and the time window. In some examples, determining intersections for each TSDB and the time window can comprise comparing the time window with a particular TSDB's availability history and identifying periods of overlap. This process can be repeated for each TSDB. After operation 906, process flow 900 moves to operation 908.

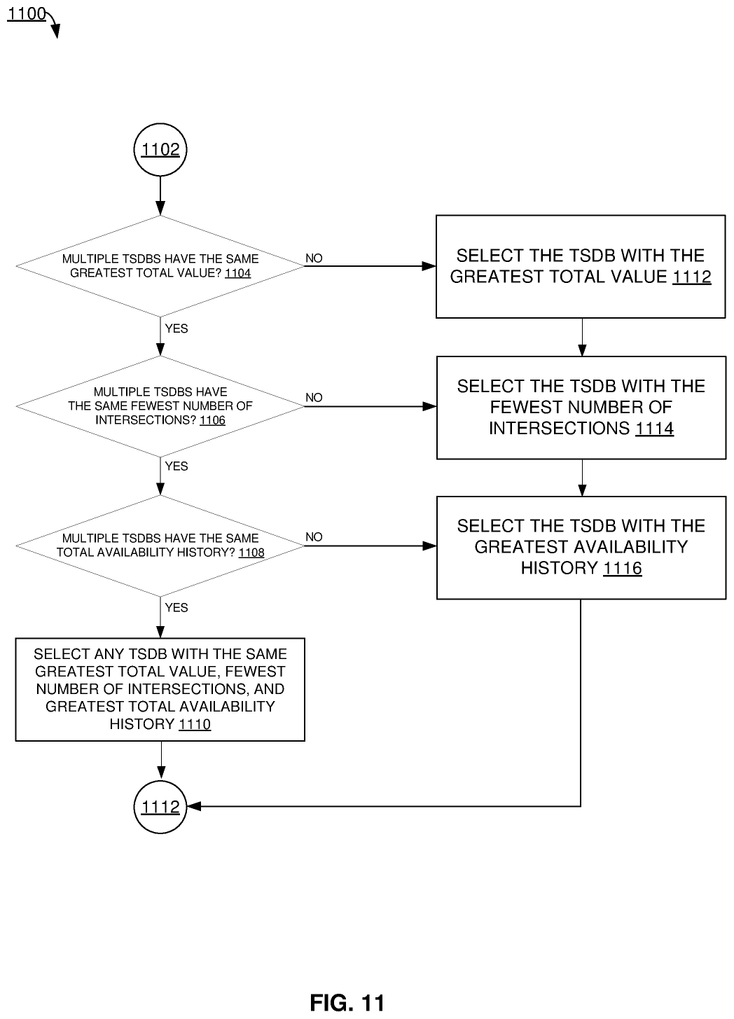

Operation 908 is reached from operation 906, or from operation 912 where it is determined in operation 912 that the time window does not have zero length. Operation 908 depicts selecting a TSDB. In some examples, a TSDB can be selected in operation 908 in a similar manner as a TSDB is selected in process flow 1100 of FIG. 11. After operation 908, process flow 900 moves to operation 910.

Operation 910 depicts updating the time window. In some examples, a time window can be updated in operation 910 similar to how a time window is updated availability histories 300 of FIG. 3 relative to availability histories 200 of FIG. 2. After operation 910, process flow 900 moves to operation 912.

Operation 912 depicts determining whether the time window has zero length. A time window can be determined to have zero length when a TSDB has been selected for each time period within a time window, and the time window is updated to having no remaining time periods in operation 910.

Where it is determined in operation 912 that the time window has zero length, then process flow 900 moves to operation 914. Instead, where it is determined in operation 912 that the time window does not have zero length, then process flow 900 returns to operation 908.

This loop of operations 908, 910, and 912 can be performed multiple times to determine which TSDBs are used to build an availability history for a time window. Each loop can be referred to as an iteration.

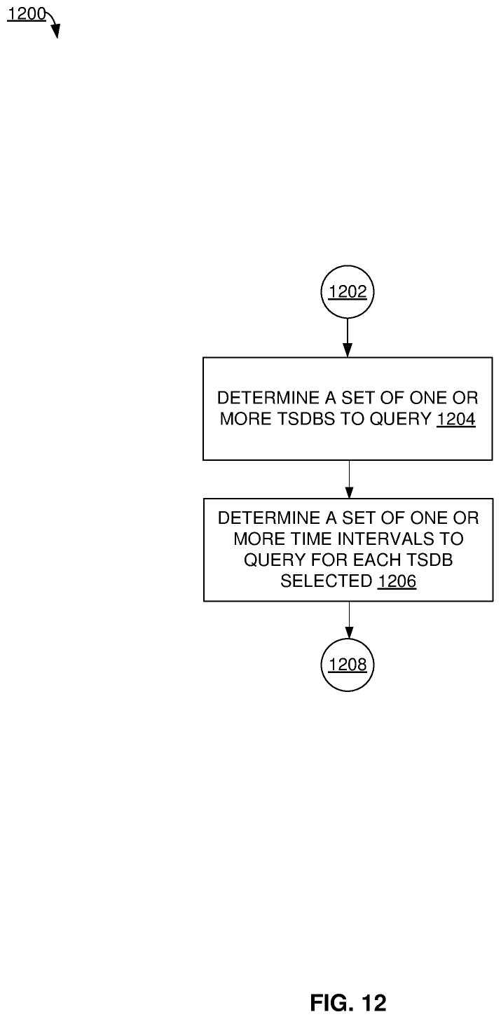

Operation 914 is reached from operation 912 where it is determined in operation 912 that the time window has zero length. Operation 914 depicts producing an output. In some examples, the output produced in operation 914 can be similar to the output produced by process flow 1200 of FIG. 12. After operation 914, process flow 900 moves to 916, where process flow 900 ends.

FIG. 10 illustrates an example process flow 1000 for determining input for monitoring computer systems, in accordance with certain embodiments of this disclosure. In some examples, process flow 1000 can be implemented by reporting server 104 of FIG. 1 in the course of facilitating a monitoring subsystem for computer systems. It can be appreciated that process flow 1000 is an example process flow, and that there can be process flows that implement more or fewer operations than are depicted in process flow 1000, and/or implement the operations of process flow 1000 in a different order than is depicted. In some examples, process flow 1000 can be implemented to produce the input of operation 904 of FIG. 9. In some examples, process flow 1000 can be implemented in conjunction with one or more other process flows of FIGS. 9 and 11-16.

Process flow 1000 begins with 1002, and then moves to operation 1004. Operation 1004 depicts determining a time window to provide monitoring data for. In some examples, this time window can be received as user input provided at dashboard 116 of FIG. 1, and sent from host 114 to reporting server 104. After operation 1004, process flow 1000 moves to operation 1006.

Operation 1006 depicts determining currently available TSDBs. In some examples, reporting server 104 of FIG. 1 can maintain a list of TSDBs and an indication of whether they are available. In such examples, determining currently available TSDBs can comprise reporting server 104 accessing its list of TSDBs for which ones are available. After operation 1006, process flow 1000 moves to operation 1008.

Operation 1008 depicts determining an availability history for the currently available TSDBs. Similar to operation 1006, in some examples, reporting server 104 of FIG. 1 can maintain a list of TSDBs and an availability history for each of these TSDBs. In such examples, determining the availability histories can comprise reporting server 104 accessing its list of TSDBs with the availability histories. After operation 1006, process flow 1000 moves to operation 1008. After operation 1008, process flow 1000 moves to 1010, where process flow 1000 ends.

FIG. 11 illustrates an example process flow 1100 for selecting a TSDB among a plurality of TSDBs for monitoring computer systems, in accordance with certain embodiments of this disclosure. In some examples, process flow 1100 can be implemented by reporting server 104 of FIG. 1 in the course of facilitating a monitoring subsystem for computer systems. It can be appreciated that process flow 1100 is an example process flow, and that there can be process flows that implement more or fewer operations than are depicted in process flow 1100, and/or implement the operations of process flow 1100 in a different order than is depicted. In some examples, process flow 1100 can be implemented to select a TSDB in operation 908 of FIG. 9. In some examples, process flow 1100 can be implemented in conjunction with one or more other process flows of FIGS. 10 and 12-16.

Process flow 1100 begins with 1102 and moves to operation 1104. Operation 1104 depicts determining whether multiple TSDBs have the same greatest total value. In some examples, determining whether multiple TSDBs have the same greatest total value can be performed in a similar matter as described with respect to FIG. 5.

Where it is determined in operation 1104 that multiple TSDBs have the same greatest total value, process flow 1104 moves to operation 1106. Instead, where it is determined in operation 1104 that multiple TSDBs do not have the same greatest total value, process flow 1104 moves to operation 1112.

Operation 1106 is reached from operation 1104 where it is determined in operation 1104 that multiple TSDBs have the same greatest total value. Operation 1106 depicts determining whether multiple TSDBs have the same fewest number of intersections. The TSDBs evaluated in operation 1106 can be a subset of TSDBs already determined to have the same greatest total value in operation 1104. In some examples, determining whether multiple TSDBs have the same fewest number of intersections can be performed in a similar manner as described with respect to FIG. 6.

Where it is determined in operation 1106 that multiple TSDBs have the same fewest number of intersections, process flow 1106 moves to operation 1114. Instead, where it is determined in operation 1104 that multiple TSDBs do not have the same fewest number of intersections, process flow 1106 moves to operation 1114.

Operation 1108 is reached from operation 1104 where it is determined in operation 1104 that multiple TSDBs have the same number of intersections. Operation 1108 depicts determining whether multiple TSDBs have the same total availability history. The TSDBs evaluated in operation 1108 can be a subset of TSDBs already determined to have the same greatest total value in operation 1104, and the same fewest number of intersections in operation 1106. In some examples, determining whether multiple TSDBs have the same total availability history can be performed in a similar manner as described with respect to FIG. 7.

Where it is determined in operation 1108 that multiple TSDBs have the same total availability history, process flow 1108 moves to operation 1110. Instead, where it is determined in operation 1108 that multiple TSDBs do not have the same total availability history, process flow 1108 moves to operation 1116.

Operation 1110 is reached from operation 1108 where it is determined in operation 1108 that multiple TSDBs have the same availability history. Operation 1110 depicts selecting any TSDB with the same greatest total value, fewest number of intersections, and greatest total availability history. The TSDBs evaluated in operation 1110 can be a subset of TSDBs already determined to have the same greatest total value in operation 1104, the same fewest number of intersections in operation 1106, and the same total availability history in operation 1108. In some examples, selecting a TSDB in operation 1110 can be performed in a similar manner as described with respect to FIG. 8. After operation 1110, process flow 1100 moves to 1118, where process flow 1100 ends.

Operation 1112 is reached from operation 1104 where it is determined that multiple TSDBs do not have the same greatest total value. Operation 1112 depicts selecting the TSDB with the greatest total value. In some examples, selecting the TSDB with the greatest total value can be performed in a similar matter as described with respect to FIG. 5. After operation 1112, process flow 1100 moves to 1118, where process flow 1100 ends.

Operation 1114 is reached from operation 1106 where it is determined that multiple TSDBs do not have the same fewest number of intersections. Operation 1112 depicts selecting the TSDB with the fewest number of intersections. The TSDBs evaluated in operation 1112 can be a subset of TSDBs already determined to have the same greatest total value in operation 1104. In some examples, de selecting the TSDB with the fewest number of intersections can be performed in a similar manner as described with respect to FIG. 6. After operation 1114, process flow 1100 moves to 1118, where process flow 1100 ends.

Operation 1116 is reached from operation 1104 where it is determined that multiple TSDBs do not have the same total availability history. Operation 1116 depicts selecting the TSDB with the greatest availability history. The TSDBs evaluated in operation 1116 can be a subset of TSDBs already determined to have the same greatest total value in operation 1104, and the same fewest number of intersections in operation 1106. In some examples, selecting the TSDB with the greatest availability history can be performed in a similar manner as described with respect to FIG. 7. After operation 1116, process flow 1100 moves to 1118, where process flow 1100 ends.

FIG. 12 illustrates an example process flow 1200 for producing output for monitoring computer systems, in accordance with certain embodiments of this disclosure. In some examples, process flow 1200 can be implemented by reporting server 104 of FIG. 1 in the course of facilitating a monitoring subsystem for computer systems. It can be appreciated that process flow 1200 is an example process flow, and that there can be process flows that implement more or fewer operations than are depicted in process flow 1200, and/or implement the operations of process flow 1200 in a different order than is depicted. In some examples, process flow 1200 can be implemented to produce an output in operation 914 of FIG. 9. In some examples, process flow 1200 can be implemented in conjunction with one or more other process flows of FIGS. 9-11 and 13-16.

Process flow 1200 begins with 1202, and moves to operation 1204. Operation 1204 depicts determining a set of one or more TSDBs to query. This set of TSDBs to query can be the TSDBs selected by implementing process flow 900 of FIG. 9. After operation 1204, process flow 1200 moves to operation 1206.

Operation 1206 depicts determining a set of one or more time intervals to query for each TSDB selected in operation 1204. In some examples, the set of time intervals for a TSDB can be those time intervals where the TSDB's availability history and the time window intersect at the point that the TSDB is selected in operation 908 of FIG. 9. That is, the time window might have been updated during previous iterations, and can be smaller than the original size of the time window. After operation 1206, process flow 1200 moves to 1208, where process flow 1200 ends.

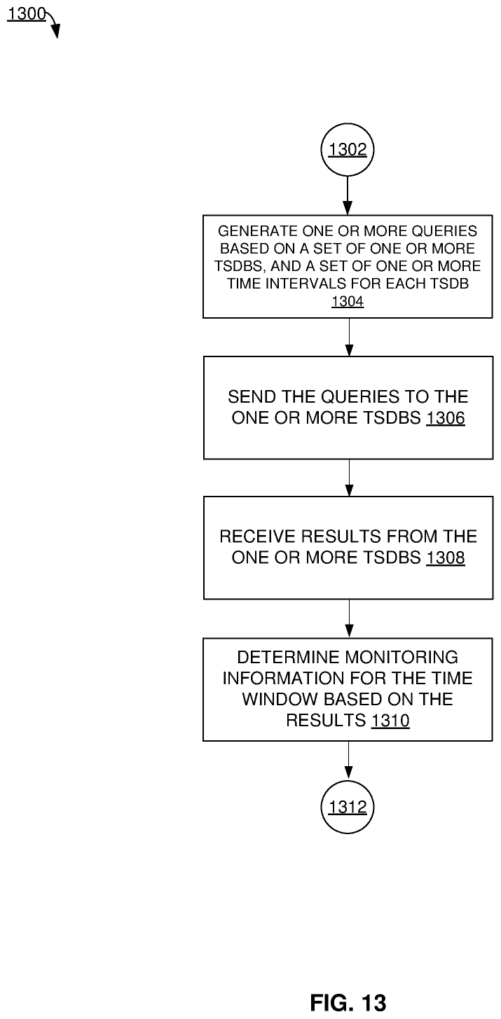

FIG. 13 illustrates an example process flow 1300 for generating monitoring information for monitoring computer systems from the output of the process flow of FIG. 12, in accordance with certain embodiments of this disclosure. In some examples, process flow 1300 can be implemented by reporting server 104 of FIG. 1 in the course of facilitating a monitoring subsystem for computer systems. It can be appreciated that process flow 1300 is an example process flow, and that there can be process flows that implement more or fewer operations than are depicted in process flow 1300, and/or implement the operations of process flow 1300 in a different order than is depicted. In some examples, process flow 1300 can be implemented in conjunction with one or more other process flows of FIGS. 9-12 and 14-16.

Process flow 1300 begins with 1302 and moves to operation 1304. Operation 1304 depicts generating one or more queries based on a set of one or more TSDBs, and a set of one or more time intervals for each TSDB. These queries can be generated using the TSDBs and time intervals identified through process flow 1200 of FIG. 2. After operation 1304, process flow 1300 moves to operation 1306.

Operation 1306 depicts sending the queries to the one or more TSDBs. In some examples, reporting server 104 of FIG. 1 can send the queries to one or more of TSDB 1 106a-1, TSDB 2 106a-2, TSDB 3 106a-3, and TSDBs 106b. After operation 1306, process flow 1300 moves to operation 1308.

Operation 1308 depicts receiving results from the one or more TSDBs. In some examples, this can comprise reporting server 104 of FIG. 1 receiving the results of the queries it sent in operation 1306 from one or more of TSDB 1 106a-1, TSDB 2 106a-2, TSDB 3 106a-3, and TSDBs 106b. After operation 1308, process flow 1300 moves to operation 1310.

Operation 1310 depicts determining monitoring information for the time window based on the results. This can comprise aggregating the results from the one or more TSDBs from operation 1308 to assemble monitoring information for the complete time window. For example, where a first TSDB is queried for monitoring results for time [t0+2, t0+4), and a second TSSDB is queried for monitoring results for times [t0+1, t0+2) and [t0+4, t0+5), then these results can be aggregated too produce monitoring results for time [t0+1, t0+5). After operation 1310, process flow 1300 moves to 1312, where process flow 1300 ends.

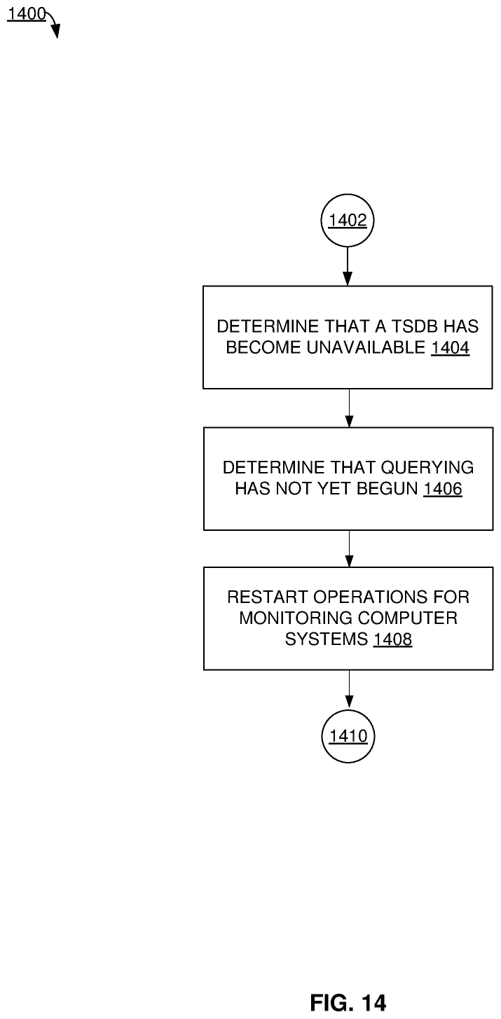

FIG. 14 illustrates an example process flow for monitoring computer systems where a TSDB becomes unavailable before querying begins, in accordance with certain embodiments of this disclosure. In some examples, process flow 1400 can be implemented by reporting server 104 of FIG. 1 in the course of facilitating a monitoring subsystem for computer systems. It can be appreciated that process flow 1400 is an example process flow, and that there can be process flows that implement more or fewer operations than are depicted in process flow 1400, and/or implement the operations of process flow 1400 in a different order than is depicted. In some examples, process flow 1400 can be implemented in tandem with process flow 900 of FIG. 9 to determine whether a TSDB becomes unavailable while process flow 900 operates. In some examples, process flow 1400 can be implemented in conjunction with one or more other process flows of FIGS. 9-13 and 15-16.

Process flow 1400 begins with 1402, and moves to operation 1404. Operation 1404 depicts determining that a TSDB has become unavailable. In some examples, a metrics reporting server (e.g., reporting server 104 of FIG. 1) can utilize a monitored network connection with a TSDB (e.g., TSDB 106a-1) to determine whether the TSDB is available or unavailable, and this may be done while process flow 900 of FIG. 9 is being implemented. After operation 1404, process flow 1400 moves to operation 1406.

Operation 1406 depicts determining that querying has not yet begun. In some examples, this comprises a metrics reporting server determine whether performing a combination of process flow 900, process flow 1200 and process flow 1300 has yet reached operation 1306, where queries are sent to one or more TSDBs. Where operation 1306 has not yet been reached, it can be determined that querying has not yet begun. After operation 1406, process flow 1400 moves to operation 1408.

Operation 1408 depicts restarting operations for monitoring computer systems. That is, where a combination of process flow 900, process flow 1200 and process flow 1300 is implemented, this can comprise returning to operation 904, and discarding information previously determined from the now-stopped previous performance (e.g., discarding a list of TSDBs to query). After operation 1408, process flow 1400 moves to 1410, where process flow 1400 ends.

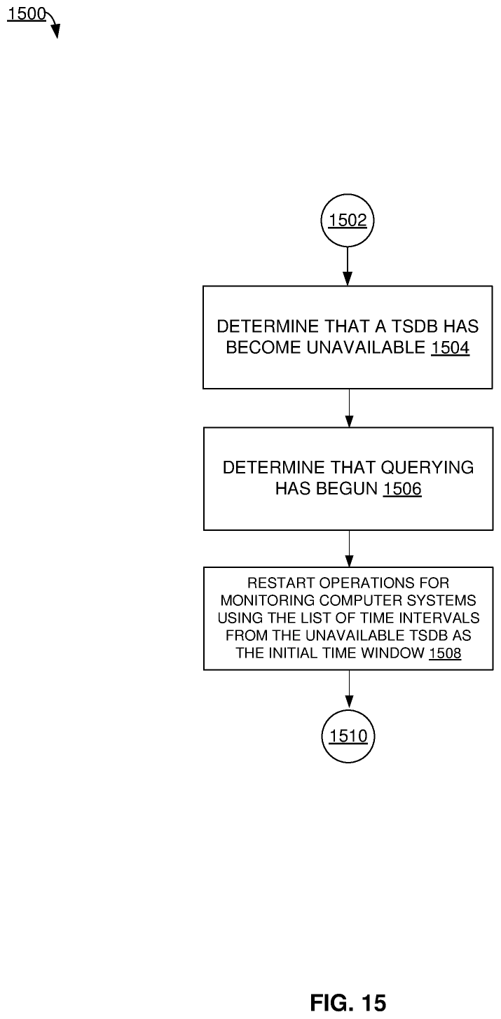

FIG. 15 illustrates an example process flow 1500 for monitoring computer systems where a TSDB becomes unavailable after querying begins, in accordance with certain embodiments of this disclosure. In some examples, process flow 1500 can be implemented by reporting server 104 of FIG. 1 in the course of facilitating a monitoring subsystem for computer systems. It can be appreciated that process flow 1500 is an example process flow, and that there can be process flows that implement more or fewer operations than are depicted in process flow 1500, and/or implement the operations of process flow 1500 in a different order than is depicted. In some examples, process flow 1500 can be implemented in tandem with process flow 900 of FIG. 9 to determine whether a TSDB becomes unavailable while process flow 900 operates. In some examples, process flow 1500 can be implemented in conjunction with one or more other process flows of FIGS. 9-14 and 16.

Process flow 1500 begins with 1502, and moves to operation 1504. Operation 1504 depicts determining that a TSDB has become unavailable. In some examples, operation 1504 can be implemented in a similar manner as operation 1404 of FIG. 14. After operation 1504, process flow 1500 moves to operation 1506.

Operation 1506 depicts determining that querying has begun. In some examples, this comprises a metrics reporting server determine whether performing a combination of process flow 900, process flow 1200 and process flow 1300 has yet reached operation 1306, where queries are sent to one or more TSDBs. Where operation 1306 has been reached, it can be determined that querying has begun. After operation 1506, process flow 1500 moves to operation 1508.

Operation 1508 depicts restarting operations for monitoring computer systems using the list of time intervals from the unavailable TSDB as the initial time window. That is, a combination of process flow 900, process flow 1200 and process flow 1300 can be performed using just the list of time windows from the unavailable TSDB as the initial time window, and keeping the determination that other TSDBs will be used for queries for other time periods. This list of time windows can be disjoint. For instance, it can be time [t0+1, t0+3) and [t0+4, t0+5). After operation 1508, process flow 1500 moves to 1510, where process flow 1500 ends.

FIG. 16 illustrates another example process flow for monitoring computer systems, in accordance with certain embodiments of this disclosure. In some examples, process flow 1600 can be implemented by reporting server 104 of FIG. 1 in the course of facilitating a monitoring subsystem for computer systems. It can be appreciated that process flow 1600 is an example process flow, and that there can be process flows that implement more or fewer operations than are depicted in process flow 1600, and/or implement the operations of process flow 1600 in a different order than is depicted. In some examples, process flow 1600 can be implemented in conjunction with one or more other process flows of FIGS. 9-15.

Process flow 1600 begins with 1602, and moves to operation 1604. Operation 1604 depicts determine a first time window for which to determine monitoring information from a group of TSDBs.

In some examples, there are a set of computing nodes of a computing cluster, and each TSDB of the group of TSDBs monitors the set of computing nodes. That is, the computing nodes can be computing nodes 110a-1 through 110a-8, and the TSDBs can be TSDB 1 106a-1, TSDB 2 106a-2, and TSDB 3 106a-3. In some examples, TSDBs store information about other computing nodes. This can be expressed as, each TSDB of the group of TSDBs stores the monitoring information corresponding to a group of computing nodes of a computing cluster. In some examples, this can be expressed as determining a corresponding availability history for each TSDB of a group of TSDBs.

After operation 1604, process flow 1600 moves to operation 1606.

Operation 1606 depicts determining a respective availability history for each TSDB of the group of TSDBs. In some examples, this can be expressed as determining respective availability histories for respective time series databases (TSDBs) of a group of TSDBs.

In some examples, operation 1606 is performed on currently available TSDBs, and TSDBs that are offline are not considered. This can be expressed as, omitting a first TSDB of the group of TSDBs that is currently unavailable from performance of the iterations of the selecting of the new one of the group of TSDBs. This can also be expressed as, the respective TSDBs of the group of TSDBs are currently available.

In some examples, a TSDB's availability history can be determined using a monitored network connection. This can be expressed as, determining a first availability history for a first TSDB of the group of TSDBs based on a monitored network connection with the first TSDB.

After operation 1606, process flow 1600 moves to operation 1608.

Operation 1608 depicts performing iterations of selecting a new one of the group of TSDBs with a greatest availability history during the first time window to produce one or more selected TSDBs until times of the first time window are covered by a combined availability history of the one or more selected TSDBs.

In some examples, selecting a TSDB can comprise selecting a TSDB with a greatest total value in the time window. This can be expressed as, selecting a first TSDB of the group of TSDBs before selecting a second TSDB of the group of TSDBs in response to determining that the first TDSB has a first respective availability history corresponding to the time window for a first amount of time, determining that the second TDSB has a second respective availability history corresponding to the time window for a second amount of time, and determining that the first amount of time is greater than the second amount of time.

In some examples where multiple TSDBs share the greatest total value in the time window, the TSDB can be selected from them that has the fewest number of intersections with the time window. This can be expressed as, selecting a first TSDB of the group of TSDBs before selecting a second TSDB of the group of TSDBs in response to determining that a first respective availability of the first TSDB during the first time window is equal to a second respective availability of the second TSDB during the first time window, and to determining that the first respective availability has a first number of intersections that is greater than a second number of intersections of the second respective availability.

In some examples, a TSDB's intersections with a time window can be summed and compared with other TSDBs as follows. These examples can include, for each TSDB of the group of TSDBs, summing a length of one or more intersections between corresponding availability histories of each TSDB and the first time window to produce of a sum of the one or more intersections, and selecting the new one of the group of TSDBs based on the new one being determined to have a greatest sum of intersections of the group of TSDBs.

In some examples where multiple TSDBs share the greatest total value in the time window, and of those TSDBs, the fewest number of intersections with the time window, a TSDB can then be selected from those TSDBs based on having the greatest availability history. This can be expressed as, selecting a first TSDB of the group of TSDBs before selecting a second TSDB of the group of TSDBs in response to determining that a first respective availability of the first TSDB during the first time window is equal to a second respective availability of the second TSDB during the first time window, to determining that the first respective availability has a first number of intersections that is equal to a second number of intersections of the second respective availability, and to determining that a first overall availability history of the first TSDB is greater than a second overall availability history of the second TSDB.

In some examples, multiple TSDBs have the same greatest total value, some of those TSDBs have the same fewest number of intersections, some of those TSDBs have the greatest availability history. In some examples where this situation occurs, any of these TSDBs with the greatest availability history can be selected in an iteration. This can be expressed as, selecting either a first TSDB of the group of TSDBs or a second TSDB of the group of TSDBs in response to determining that a first availability of the first TSDB during the first time window is equal to a second availability of the second TSDB during the first time window, in response to determining that the first availability has a first number of intersections that is equal to a second number of intersections of the second availability, and in response to determining that a first overall availability history of the first TSDB is equal to a second overall availability history of the second TSDB.

After operation 1608, process flow 1600 moves to operation 1610.

Operation 1610 depicts querying each TSDB of the one or more selected TSDBs for monitoring data corresponding to the respective availability history of each TSDB of the one or more selected TSDBs.

In some examples, only one TSDB is queried for monitoring information for a particular time. This can be expressed as a situation where a first TSDB of the group of TSDBs has a first respective availability history, a second TSDB of the group of TSDBs has a second respective availability history, performance of the iterations of the selecting comprises selecting the first TSDB of the group of TSDBs before selecting the second TSDB of the group of TSDBs. Then, this can further be expressed as, querying the second TSDB for a portion of the second respective availability history that is disjoint from the first respective availability history.

In some examples, a selected TSDB becomes unavailable before querying the TSDBs, and the iterations can be re-performed. This can comprise performing iterations of selecting a second time to produce at least one second selected TSDB in response to determining a first TSDB of the at least one first selected TSDB becomes unavailable before performing the querying, and performing the querying and the determining the monitoring information based on the at least one second selected TSDB.

In some examples, a TSDB becomes unavailable after beginning querying, and the iterations can be re-performed using the unavailable TSDB's time window for querying as the new time window. This can be expressed as, performing the selecting, the querying, and the determining the monitoring information a second time using a second time window corresponding to an availability history of a first TSDB of the at least one selected TSDB in response to determining that the first TSDB has become unavailable after beginning the querying a first time.

In some examples, one query to a TSDB can contain multiple non-adjacent time intervals. This can be expressed as, sending a first query to a first TSDB of the at least one selected TSDB, the first query identifying a group of non-adjacent time intervals.

In some examples, even though multiple TSDBs can have monitoring data for a given time, only one TSDB is queried for that particular time. This can be expressed as, querying a first selected TSDB of the one or more selected TSDBs for first monitoring data corresponding to a first time without querying a second selected TSDB of the one or more selected TSDBs for the first time.

In some examples, a time window may fall outside the TSDBs known collective availability histories. That is, the time window can go further back in time than the oldest known time for which TSDBs maintain monitoring information. In such examples, it can be that monitoring data is requested from all currently available TSDBs, and then a metrics reporting server performs the task of removing duplicate data and assembling monitoring data for the time window. This can be expressed as, in response to determining that the monitoring data is requested for a first time period beyond a known availability history of the group of TSDBs, querying each of the group of TSDBs that is currently available for at least some of the monitoring information corresponding to the first time period.

In some examples, monitoring data (or monitoring information) comprises at least one central processing unit (CPU) utilization of a computing cluster node monitored by the group of TSDBs, and a random access memory (RAM) consumption of the computing cluster node.

After operation 1610, process flow 1600 moves to operation 1612.

Operation 1612 depicts determining the monitoring information based on a response from the querying each TSDB of the one or more selected TSDBs. In some examples, operation 1612 can be implemented in a similar manner as operation 1310 of FIG. 3. In some examples, this can be expressed as, determining monitoring information based on each response from querying each selected TSDB of the one or more selected TSDBs for monitoring data associated with corresponding availability histories of each selected TSDB. After operation 1612, process flow 1600 moves to 1614, where process flow 1600 ends.

### Example Operating Environment

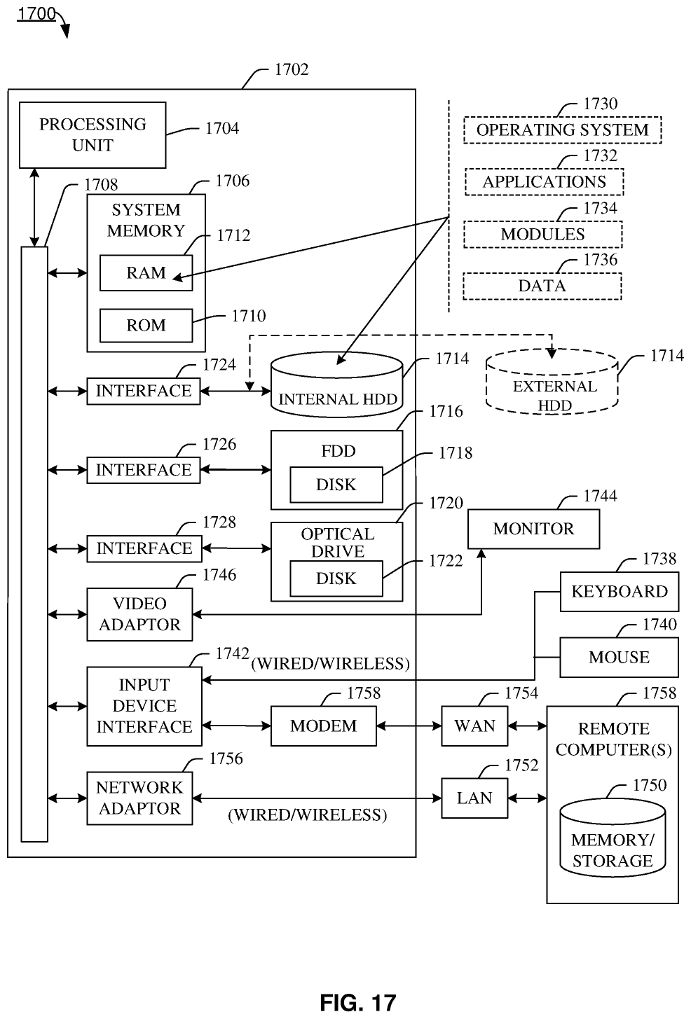

To provide further context for various aspects of the subject specification, FIG. 17 illustrates an example of an embodiment of a system 1700 that may be used in connection performing certain embodiments of this disclosure. For example, aspects of system 1700 can be used to implement aspects of host 114, reporting server 104, TSDB 1 106a-1, TSDB 2 106a-2, TSDB 3 106a-2, TSDBs 106b, computing node 110a-1, computing node 110a-2, computing node 110a-3, computing node 110a-4, computing node 110a-5, computing node 110a-6, computing node 110a-7, computing node 110a-8, and computing nodes 110b. In some examples, system 1700 can implement aspects of the operating procedures of process flow 900 of FIG. 9, process flow 1000 of FIG. 10, process flow 1100 of FIG. 11, process flow 1200 of FIG. 12, process flow 1300 of FIG. 13, process flow 1400 of FIG. 14, process flow 1500 of FIG. 15, and/or process flow 1600 of FIG. 16 to facilitate a monitoring subsystem for computer systems.

FIG. 17 illustrates an example of an embodiment of a system 1700 that may be used in connection performing certain embodiments of this disclosure. The system 1700 includes a data storage system 1712 connected to host systems 1714a-14n through communication medium 1718. In this embodiment of the computer system 1700, and the n hosts 1714a-14n may access the data storage system 1712, for example, in performing input/output (I/O) operations or data requests. The communication medium 1718 may be any one or more of a variety of networks or other type of communication connections as known to those skilled in the art. The communication medium 1718 may be a network connection, bus, and/or other type of data link, such as a hardwire or other connections known in the art. For example, the communication medium 1718 may be the Internet, an intranet, network (including a Storage Area Network (SAN)) or other wireless or other hardwired connection(s) by which the host systems 1714a-14n may access and communicate with the data storage system 1712, and may also communicate with other components included in the system 1700.

Each of the host systems 1714a-14n and the data storage system 1712 included in the system 1700 may be connected to the communication medium 1718 by any one of a variety of connections as may be provided and supported in accordance with the type of communication medium 1718. The processors included in the host computer systems 1714a-14n may be any one of a variety of proprietary or commercially available single or multi-processor system, such as an Intel-based processor, or other type of commercially available processor able to support traffic in accordance with each particular embodiment and application.

It should be noted that the particular examples of the hardware and software that may be included in the data storage system 1712 are described herein in more detail, and may vary with each particular embodiment. Each of the host computers 1714a-14n and data storage system may all be located at the same physical site, or, alternatively, may also be located in different physical locations. Examples of the communication medium that may be used to provide the different types of connections between the host computer systems and the data storage system of the system 1700 may use a variety of different communication protocols such as SCSI, Fibre Channel, iSCSI, and the like. Some or all of the connections by which the hosts and data storage system may be connected to the communication medium may pass through other communication devices, such switching equipment that may exist such as a phone line, a repeater, a multiplexer or even a satellite.

Each of the host computer systems may perform different types of data operations in accordance with different types of tasks. In the embodiment of FIG. 17, any one of the host computers 1714a-14n may issue a data request to the data storage system 1712 to perform a data operation. For example, an application executing on one of the host computers 1714a-14n may perform a read or write operation resulting in one or more data requests to the data storage system 1712.

It should be noted that although element 1712 is illustrated as a single data storage system, such as a single data storage array, element 1712 may also represent, for example, multiple data storage arrays alone, or in combination with, other data storage devices, systems, appliances, and/or components having suitable connectivity, such as in a SAN, in an embodiment using the techniques herein. It should also be noted that an embodiment may include data storage arrays or other components from one or more vendors. In subsequent examples illustrated the techniques herein, reference may be made to a single data storage array by a vendor, such as by EMC Corporation of Hopkinton, Mass. However, as will be appreciated by those skilled in the art, the techniques herein are applicable for use with other data storage arrays by other vendors and with other components than as described herein for purposes of example.

The data storage system 1712 may be a data storage array including a plurality of data storage devices 1716a-16n. The data storage devices 1716a-16n may include one or more types of data storage devices such as, for example, one or more disk drives and/or one or more solid state drives (SSDs). An SSD is a data storage device that uses solid-state memory to store persistent data. An SSD using SRAM or DRAM, rather than flash memory, may also be referred to as a RAM drive. SSD may refer to solid state electronics devices as distinguished from electromechanical devices, such as hard drives, having moving parts. Flash devices or flash memory-based SSDs are one type of SSD that contains no moving parts. As described in more detail in following paragraphs, the techniques herein may be used in an embodiment in which one or more of the devices 1716a-16n are flash drives or devices. More generally, the techniques herein may also be used with any type of SSD although following paragraphs may make reference to a particular type such as a flash device or flash memory device.

The data storage array may also include different types of adapters or directors, such as an HA 1721 (host adapter), RA 1740 (remote adapter), and/or device interface 1723. Each of the adapters may be implemented using hardware including a processor with local memory with code stored thereon for execution in connection with performing different operations. The HAs may be used to manage communications and data operations between one or more host systems and the global memory (GM). In an embodiment, the HA may be a Fibre Channel Adapter (FA) or other adapter which facilitates host communication. The HA 1721 may be characterized as a front end component of the data storage system which receives a request from the host. The data storage array may include one or more RAs that may be used, for example, to facilitate communications between data storage arrays. The data storage array may also include one or more device interfaces 1723 for facilitating data transfers to/from the data storage devices 1716a-16n. The data storage interfaces 1723 may include device interface modules, for example, one or more disk adapters (DAs) (e.g., disk controllers), adapters used to interface with the flash drives, and the like. The DAs may also be characterized as back end components of the data storage system which interface with the physical data storage devices.

One or more internal logical communication paths may exist between the device interfaces 1723, the RAs 1740, the HAs 1721, and the memory 1726. An embodiment, for example, may use one or more internal busses and/or communication modules. For example, the global memory portion 1725b may be used to facilitate data transfers and other communications between the device interfaces, HAs and/or RAs in a data storage array. In one embodiment, the device interfaces 1723 may perform data operations using a cache that may be included in the global memory 1725b, for example, when communicating with other device interfaces and other components of the data storage array. The other portion 1725a is that portion of memory that may be used in connection with other designations that may vary in accordance with each embodiment.

The particular data storage system as described in this embodiment, or a particular device thereof, such as a disk or particular aspects of a flash device, should not be construed as a limitation. Other types of commercially available data storage systems, as well as processors and hardware controlling access to these particular devices, may also be included in an embodiment.

Host systems provide data and access control information through channels to the storage systems, and the storage systems may also provide data to the host systems also through the channels. The host systems do not address the drives or devices 1716a-16n of the storage systems directly, but rather access to data may be provided to one or more host systems from what the host systems view as a plurality of logical devices or logical volumes (LVs). The LVs may or may not correspond to the actual physical devices or drives 1716a-16n. For example, one or more LVs may reside on a single physical drive or multiple drives. Data in a single data storage system, such as a single data storage array, may be accessed by multiple hosts allowing the hosts to share the data residing therein. The HAs may be used in connection with communications between a data storage array and a host system. The RAs may be used in facilitating communications between two data storage arrays. The DAs may be one type of device interface used in connection with facilitating data transfers to/from the associated disk drive(s) and LV(s) residing thereon. A flash device interface may be another type of device interface used in connection with facilitating data transfers to/from the associated flash devices and LV(s) residing thereon. It should be noted that an embodiment may use the same or a different device interface for one or more different types of devices than as described herein.

The device interface, such as a DA, performs I/O operations on a drive 1716a-16n. In the following description, data residing on an LV may be accessed by the device interface following a data request in connection with I/O operations that other directors originate. Data may be accessed by LV in which a single device interface manages data requests in connection with the different one or more LVs that may reside on a drive 1716a-16n. For example, a device interface may be a DA that accomplishes the foregoing by creating job records for the different LVs associated with a particular device. These different job records may be associated with the different LVs in a data structure stored and managed by each device interface.

Also shown in FIG. 17 is a service processor 1722a that may be used to manage and monitor the system 1712. In one embodiment, the service processor 1722a may be used in collecting performance data, for example, regarding the I/O performance in connection with data storage system 1712. This performance data may relate to, for example, performance measurements in connection with a data request as may be made from the different host computer systems 1714a 1714n. This performance data may be gathered and stored in a storage area. Additional detail regarding the service processor 1722a is described in following paragraphs.

It should be noted that a service processor 1722a may exist external to the data storage system 1712 and may communicate with the data storage system 1712 using any one of a variety of communication connections. In one embodiment, the service processor 1722a may communicate with the data storage system 1712 through three different connections, a serial port, a parallel port and using a network interface card, for example, with an Ethernet connection. Using the Ethernet connection, for example, a service processor may communicate directly with DAs and HAs within the data storage system 1712.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. In an aspect, when a processor executes instructions to perform “operations”, this could include the processor performing the operations directly and/or facilitating, directing, or cooperating with another device or component to perform the operations.

In the subject specification, terms such as “data store,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile memory, or can include both volatile and nonvolatile memory. By way of illustration, and not limitation, nonvolatile memory can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated aspects of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or API components.

Further, the various embodiments can be implemented as a method, apparatus, or article of manufacture using standard programming and/or engineering techniques to produce software, firmware, hardware, or any combination thereof to control a computer to implement one or more aspects of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the first processor, facilitate performance of operations, comprising:
determine a first time window for which to determine monitoring information from a group of time series databases (TSDBs);
determine a respective availability history for each TSDB of the group of TSDBs;
perform iterations of selecting a new one of the group of TSDBs with a greatest availability history during the first time window to produce one or more selected TSDBs until times of the first time window are covered by a combined availability history of the one or more selected TSDBs;
query each TSDB of the one or more selected TSDBs for monitoring data corresponding to the respective availability history of each TSDB of the one or more selected TSDBs; and
determine the monitoring information based on a response from the querying each TSDB of the one or more selected TSDBs.

2. The system of claim 1, wherein a first TSDB of the group of TSDBs has a first respective availability history, wherein, a second TSDB of the group of TSDBs has a second respective availability history, wherein performance of the iterations of the selecting comprises selecting the first TSDB of the group of TSDBs before selecting the second TSDB of the group of TSDBs, and wherein the querying each TSDB of the one or more selected TSDBs for the monitoring of the data corresponding to the respective availability history comprises:
querying the second TSDB for a portion of the second respective availability history that is disjoint from the first respective availability history.

3. The system of claim 1, further comprising a set of computing nodes of a computing cluster, and wherein each TSDB of the group of TSDBs monitors the set of computing nodes.

4. The system of claim 1, wherein the operations further comprise:
omitting a first TSDB of the group of TSDBs that is currently unavailable from performance of the iterations of the selecting of the new one of the group of TSDBs.

5. The system of claim 1, wherein performance of the iterations of the selecting comprises:
selecting a first TSDB of the group of TSDBs before selecting a second TSDB of the group of TSDBs in response to determining that the first TDSB has a first respective availability history corresponding to the time window for a first amount of time, determining that the second TDSB has a second respective availability history corresponding to the time window for a second amount of time, and determining that the first amount of time is greater than the second amount of time.

6. The system of claim 1, wherein performance of the iterations of the selecting comprises:
selecting a first TSDB of the group of TSDBs before selecting a second TSDB of the group of TSDBs in response to determining that a first respective availability of the first TSDB during the first time window is equal to a second respective availability of the second TSDB during the first time window, and to determining that the first respective availability has a first number of intersections that is greater than a second number of intersections of the second respective availability.

7. The system of claim 1, wherein performance of the iterations of the selecting comprises:
selecting a first TSDB of the group of TSDBs before selecting a second TSDB of the group of TSDBs in response to determining that a first respective availability of the first TSDB during the first time window is equal to a second respective availability of the second TSDB during the first time window, to determining that the first respective availability has a first number of intersections that is equal to a second number of intersections of the second respective availability, and to determining that a first overall availability history of the first TSDB is greater than a second overall availability history of the second TSDB.

8. A method, comprising:
determining, by a system comprising a processor, respective availability histories for respective time series databases (TSDBs) of a group of TSDBs;
performing, by the system, iterations of selecting a new one of the group of TSDBs with at least a threshold availability history during a first time window to produce at least one selected TSDB until times of the first time window are covered by a combined availability history of the at least one selected TSDB;
querying, by the system, the at least one selected TSDB to monitor data corresponding to at least one respective availability history of the at least one selected TSDB; and
determining, by the system, the monitoring data based on respective responses from the querying of the at least one selected TSDB.

9. The method of claim 8, wherein the performing the iterations of the selecting comprises:
selecting either a first TSDB of the group of TSDBs or a second TSDB of the group of TSDBs in response to determining that a first availability of the first TSDB during the first time window is equal to a second availability of the second TSDB during the first time window, in response to determining that the first availability has a first number of intersections that is equal to a second number of intersections of the second availability, and in response to determining that a first overall availability history of the first TSDB is equal to a second overall availability history of the second TSDB.

10. The method of claim 8, wherein the respective TSDBs of the group of TSDBs are currently available.

11. The method of claim 10, wherein the at least one selected TSDB is at least one first selected TSDB, and further comprising:
performing, by the system, iterations of selecting a second time to produce at least one second selected TSDB in response to determining a first TSDB of the at least one first selected TSDB becomes unavailable before performing the querying; and
performing, by the system, the querying and the determining the monitoring information based on the at least one second selected TSDB.

12. The method of claim 10, further comprising:
performing the selecting, the querying, and the determining the monitoring information a second time using a second time window corresponding to an availability history of a first TSDB of the at least one selected TSDB in response to determining that the first TSDB has become unavailable after beginning the querying a first time.

13. The method of claim 8, wherein the determining the respective availability histories for the respective TSDBs of the group of TSDBs comprises:
determining, by the system, a first availability history for a first TSDB of the group of TSDBs based on a monitored network connection with the first TSDB.

14. The method of claim 8, wherein the querying the at least one selected TSDB for the monitoring data corresponding to the respective availability histories comprises:
sending a first query to a first TSDB of the at least one selected TSDB, the first query identifying a group of non-adjacent time intervals.

15. A computer-readable storage medium comprising instructions that, in response to execution, cause a system comprising a processor to perform operations, comprising:
determining a corresponding availability history for each time series database (TSDB) of a group of TSDBs;
performing iterations of selecting a new one of the group of TSDBs with the corresponding availability history that satisfies at least a threshold availability criterion during a first time window to produce one or more selected TSDBs until times of the first time window are covered by a combined availability history of the one or more selected TSDBs; and
determining monitoring information based on each response from querying each selected TSDB of the one or more selected TSDBs for monitoring data associated with corresponding availability histories of each selected TSDB.

16. The computer-readable storage medium of claim 15, wherein the querying each selected TSDB of the one or more selected TSDBs for the monitoring data associated with the corresponding availability histories comprises:
querying a first selected TSDB of the one or more selected TSDBs for first monitoring data corresponding to a first time without querying a second selected TSDB of the one or more selected TSDBs for the first time.

17. The computer-readable storage medium of claim 15, wherein the operations further comprise:
in response to determining that the monitoring data is requested for a first time period beyond a known availability history of the group of TSDBs, querying each of the group of TSDBs that is currently available for at least some of the monitoring information corresponding to the first time period.

18. The computer-readable storage medium of claim 15, wherein the performing the iterations of the selecting of the new one of the group of TSDBs with the corresponding availability history that satisfies at least the threshold availability criterion comprises:
for each TSDB of the group of TSDBs, summing a length of one or more intersections between corresponding availability histories of each TSDB and the first time window to produce of a sum of the one or more intersections; and
selecting the new one of the group of TSDBs based on the new one being determined to have a greatest sum of intersections of the group of TSDBs.

19. The computer-readable storage medium of claim 15, wherein the monitoring information comprises at least one central processing unit (CPU) utilization of a computing cluster node monitored by the group of TSDBs, and a random access memory (RAM) consumption of the computing cluster node.

20. The computer-readable storage medium of claim 15, wherein each TSDB of the group of TSDBs stores the monitoring information corresponding to a group of computing nodes of a computing cluster.
